(19) United States
(12) Patent Application Publication
(10) Pub. No.: US 2015/0267865 A1
(43) Pub. Date: Sep. 24, 2015

(54) METHOD AND FILLING DEVICE FOR FILLING A STORAGE TANK WITH A PRESSURISED, GASEOUS MEDIUM

(71) Applicant: LINDE AKTIENGESELLSCHAFT, München (DE)

(72) Inventors: Robert Adler, Gerasdorf (AT); Martin Pfandl, Rust im Tullnerfeld (AT); Markus Rasch, Sulz im Wienerwald (AT); Michael Stefan, Zillingdorf (AT)

(21) Appl. No.: 14/437,081

(22) PCT Filed: Oct. 2, 2013
(86) PCT No.: PCT/EP2013/002973

§ 371 Date: Apr. 20, 2015

(30) Foreign Application Priority Data
Nov. 2, 2012 (DE) 10 2012 021 693.9
Jan. 31, 2013 (DE) 10 2013 001 676.2

(51) Int. Cl. F17C 5/06

(52) U.S. Cl. CPC F17C 5/06; F17C 2221/012; F17C 2223/0123; F17C 2225/0123; F17C 2223/036; F17C 2227/0339; F17C 2250/032; F17C 2265/061

(57) ABSTRACT

The invention relates to a method for filling a storage tank, in particular, a vehicle tank, with a pressurized, gaseous medium, in particular hydrogen, in which each storage tank (8) is filled with said medium via a tank supply line (30) and a filling coupling (19) which is provided on one end section (30a) of the tank supply line (30). Prior to filling the storage tank (8), a cold accumulator (7) provided upstream of the filling coupling (19) on the end section (30a) of the tank supply line (30) is cooled to a predetermined operational temperature such that the medium which, in a first phase of the filling of the storage tank (8), flows through the tank supply line (30) where it is in particular warmed, is cooled by the cold accumulator (7) to a predetermined desired temperature. When the tank supply line (30) has been cooled due to the effect of the medium flowing back, said cold accumulator (7) is cooled again in a second phase of filling the storage tank (8) by a medium flowing back. The invention also relates to a corresponding filling device.

The invention relates to a method and a filling device for filling a storage tank with a pressurized, gaseous medium.

Vehicles that are filled with gaseous hydrogen as the fuel require specially designed filling stations, which feed the hydrogen kept under a comparatively high pressure (e.g., 700 bar) into the vehicle tank or connected storage tank. In order to establish a comprehensive standard for manufacturers that governs the filling process at these filling stations for hydrogen-powered vehicles, a consortium consisting of several vehicle makers among other parties formulated the SAE J2601 guidelines. This standard prescribes guidelines, safety-relevant limits and performance requirements for the filling process at said filling stations. For example, it is provided that hydrogen-powered vehicles be filled to 700 bar within 3 minutes, without the temperature of the storage tank (e.g., the vehicle tank) in the process rising in excess of a temperature of 85° C. (caused by the rapid pressure increase in the storage tank owing to inflowing hydrogen). At the same time, it is required that the temperature of the hydrogen not drop below −40° C. while entering the storage tank during the filling process. Likewise, there are rules governing permissible temperature fluctuations in the filling process.

In order both not to exceed the maximum permissible temperature of in particular 85° C. during the filling process while at the same time not dropping below the limited precooling of the hydrogen of −40° C., the hydrogen for filling a storage tank must among other things thus be kept within a comparatively narrow temperature range of −40° C. to −33° C. within a specific timespan (e.g., 25 s), wherein the hydrogen temperature is usually measured at the entry into the fuel hose for the storage tank.

Due to the variable tubing lengths at the aforesaid filling stations and changing temperature conditions in the tubing, realizing a constant temperature for the hydrogen (e.g., of −40° C.) at the pump is relatively time-consuming and cost-intensive in prior art. Among other things, for example, this is because each filling process leads to a temporary drop in the tank supply line temperature, and to a readjustment of the tank supply line temperature to the ambient temperature upon completion of the filling process. Therefore, the tank supply line temperature at the start of the filling process depends heavily on how long ago a potentially preceding filling process took place, which results in a variable introduction of heat to the hydrogen flowing in the tank supply line. An excessively heated tank supply line can cause the hydrogen at the pump not to reach the prescribed temperature range of −0.33° C. to −40° C. within a timeframe that has to be observed, so that the filling process must be aborted.

In long tank supply lines, the tank line must be cooled to prevent this, but this is associated with comparatively high costs.

Proceeding from the above, the object of the present invention is thus to provide a method of the kind mentioned at the outset in which the aforesaid medium, in particular hydrogen, for filling a storage container (e.g., vehicle tank) can be kept at a permissible temperature in a comparatively cost-effective manner.

This object is achieved with a method having the features in claim 1.

In the method for filling the storage tank with a pressurized, gaseous medium, in particular hydrogen, the latter provides that this storage container be filled with the aforesaid medium via a tank supply line and a filling coupling furnished on an end section of the tank supply line, wherein a cold accumulator (for cooling the medium) provided on said end section of the tank supply line upstream from the filling coupling is cooled to a predetermined operating temperature before the storage tank is filled, so that the medium that flows through the tank supply line in a first phase of filling the storage tank, and in particular is heated in the tank supply line in the process, is cooled by the cold accumulator to a predefined desired temperature, wherein, once the tank supply line has been cooled by back-flowing medium, the cold accumulator is again cooled by back-flowing medium in a second phase of filling the storage tank.

Therefore, the cooling capacity to be additionally conveyed to the cold accumulator only corresponds to a bit more than the power dissipation, which depends on the insulation of the cold accumulator and connecting lines (tank supply line). The cold accumulator is kept at an operating temperature of preferably −40° C., in particular in the filling process as well. The cold accumulator preferably keeps the medium relayed into the storage tank at a desired temperature ranging from −40° C. to −33° C. The cold energy in the cold accumulator can here be configured in such a way that the mass flow of the medium/hydrogen can be cooled from a temperature of +40° C. to −40° C. within a time span of 50 s to 90 s, for example.

A further advantage to the cold accumulator is that it has a “temperature smoothing” effect. This makes it significantly easier to control the temperature (e.g., with a bypass function or the like), since even excessively low temperatures can be balanced out. For example, the temperature of the medium in the method according to the invention is prevented from fluctuating down to lower temperatures of below −40° C., because the cold accumulator correspondingly heats up the medium that was supercooled (i.e., kept at below −40° C.), so that the temperature of the medium flowing into the storage tank again lies within the aforesaid desired temperature range.

Another variant of the method according to the invention provides that the cold accumulator be cooled to the prescribed operating temperature before filling the storage tank by way of a cooling circuit, which is coupled with an additional cold accumulator of a refrigerating machine provided on the tank supply line upstream from the cold accumulator, so that the cooling circuit extracts heat from the cold accumulator and cools it. The aforesaid refrigerating machine or the additional cold accumulator is used to cool the medium as it enters into the tank supply line or fuel pump line.

In addition, the object according to the invention is achieved with a filling device for filling a storage tank (e.g., vehicle tank) with a gaseous, pressurized medium (e.g., hydrogen) having the features in claim 4.

According to the latter, the cold accumulator is provided upstream from the filling coupling on an end section of the tank supply line. Therefore, the filling device in particular exhibits a cold accumulator situated in such a way that the passage of the medium from the cold accumulator to the storage tank is short by comparison to the entire tank supply line (from the other cold accumulator to the filling coupling).

The cold accumulator is here preferably located upstream from a tank hose of the tank supply line, whose free end is provided with this filling coupling, which can be used to connect the tank hose with the storage tank, so that this medium can be guided into the storage tank via the tank hose. The cold accumulator is preferably situated directly in front of a breakaway coupling, which allows the tank hose to separate from the remaining tank supply line under tension (e.g., when a vehicle with engaged filling coupling drives away from the gas pump). Arranging the cold accumulator directly in front of the breakaway coupling here means in particular that the medium covers the shortest possible distance from the cold accumulator to the breakaway coupling or in the storage tank by comparison to the overall length of the tank supply line. This ensures that the temperature of the medium proceeding from the cold accumulator can only be changed to a slight extent by outside influences before it is injected into the storage tank.

The cold accumulator preferably exhibits a body made of metal, in particular aluminum, which envelops a section of the tank supply line (end section) or forms that section of the tank supply line, so that heat from the medium streaming through the body of the cold accumulator can be conveyed to this (cooled) body. The body is here preferably cooled by a cooling circuit in which a coolant circulates.

An advantageous embodiment of the filling device according to the invention is characterized by the fact that the cold accumulator consists of a metal body, in particular an aluminum body, which envelops a section of the tank supply line (end section) or forms that section of the tank supply line, and that several wires, preferably stainless steel wires, are situated inside the line section enveloped by the cold accumulator or inside the line section formed by the cold accumulator.

The inner diameter of the aforementioned line section here measures 14 mm, for example, and the diameter of the (stainless steel) wires situated in this line section measures 4 mm, for example. The number and/or diameter of wires to be provided depend on the desired passage or pressure loss. This structural configuration of the filling device according to the invention makes it possible to decrease the volume of gas to be relieved after a filling process has concluded, and thus significantly reduce the losses in hydrogen during the relieving phase. In addition, this structural configuration of the inventive filling device results in an increased heat exchanger surface and storage mass of the cold accumulator, and in an increased heat transfer coefficient.

A preferred embodiment of the invention provides that, order to cool the cold accumulator with this cooling circuit, the cold accumulator be coupled with an additional cold accumulator of a refrigerating machine that preferably also exhibits a body made out of metal, in particular aluminum, which envelops a section of the tank supply line upstream from the cold accumulator or forms that section of the tank supply line, so that the additional cold accumulator is conveyed to this (cooled) body. The body of the additional cold accumulator is here preferably cooled by an additional cooling circuit in which a coolant circulates.

In the method according to the invention and filling device according to the invention, in particular the cooling capacity to be conveyed to the cold accumulator corresponds to the loss in power caused by dissipative processes (e.g., injection of heat into the cold accumulator and tank supply line from the outside environment).

At the start of the filling process, the medium used for filling purposes cools off the initially comparatively warmer tank supply line during the filling process, consequently also acting in principle as a coolant for the tank supply line. The cold accumulator then extracts the heat injected through the tank supply line from the medium, and in so doing warms itself up to a certain degree. Therefore, the total amount of heat injected into the cold accumulator depends on the dissipative heat injected into the tank supply line and heat injected into the cold accumulator itself. This total heat injection is compensated by the aforesaid cool ing circuit, which connects the one cold accumulator on the end section of the tank supply line with the additional cold accumulator on the inlet of the tank supply line.

As a consequence, the cold accumulator in the method according to the invention only has to be able to absorb somewhat more than its own power dissipation and the power dissipation of the tank supply line. This takes place by way of the cooling circuit of the cold accumulator that is coupled with the additional cold accumulator.

Additional details and advantages of the invention will be explained with the following description of figures for an exemplary embodiment based upon a FIGURE.

Shown on:

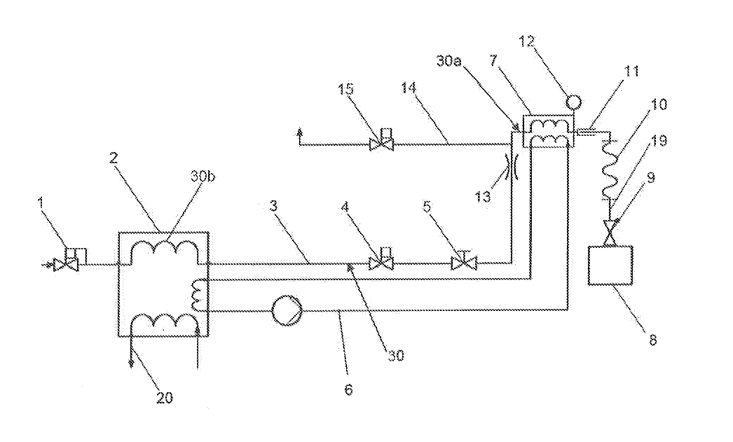

FIG. 1 is a schematic view of a filling device for implementing the method according to the invention.

FIG. 1 shows a filling device for hydrogen-powered vehicles for filling a storage tank (vehicle tank) 8 of a vehicle that can be connected with the filling device with gaseous hydrogen. Of course, the filling device according to the invention and method according to the invention can also be used to fill storage tanks 8 with other, in particular gaseous and pressurized, media.

The filling device exhibits a tank supply line 30, which extracts the hydrogen from a reservoir (not shown), and relays it to the storage tank 8 by way of a filling coupling 19 provided on an end section 30a of the tank supply line 30. At the end section 30a of the tank supply line 30, the invention provides a cold accumulator (“Alu Coldfill”) 7 for cooling the hydrogen to be introduced into the storage tank 8. In order to adjust the temperature of the hydrogen, the cold accumulator 7 exhibits a body (block) made out of aluminum, which envelops portions of this end section 30a of the tank supply line 30, and can thus extract or supply heat to the hydrogen streaming through.

In order to fill the storage tank 8 with hydrogen, the inlet of the tank supply line 30 is further provided with a valve 1 equipped with a ramp regulator followed by an additional cold accumulator (“Alu Coldfill”) 2. The additional cold accumulator 2 also exhibits a body (block) made out of aluminum, which envelops a section 30b of the tank supply line 30, and adjusts the temperature of the hydrogen flowing through this section 30b to a temperature in particular of −40° C. via heat transfer. The aforesaid block 2 is here cooled by a cooling circuit 20, which together with the additional cold accumulator 2 forms a refrigerating machine.

The cold accumulator 7 on the end section 30a of the tank supply line 30 is also cooled by a cooling circuit 6, which couples the cold accumulator 7 with the additional cold accumulator 2, so that the cold accumulator 7 is cooled by the additional cold accumulator 2.

The aforesaid additional cold accumulator 2 is connected with a preferably pneumatically operated filling valve 4 (inlet valve of gas pump) by way of a gas pump line 3, which comprises a significant portion of the entire tank supply line 30. Provided downstream from the filling valve 4 is a hand valve 5 for manually blocking the tank supply line 30, followed by a flowmeter 13 set up and provided for measuring the mass flow of the hydrogen in the tank supply line 30.

A flue line 14 branches away from the tank supply line 3 downstream from the mass flowmeter 13, so that hydrogen can be released into the environment in a controlled manner through a vent valve 15 located in the flue line 14. Situated downstream from the flowmeter 13 is the aforesaid cold accumulator 7, which is adjoined by a breakaway coupling 11 (with as short a connection as possible) that detachably couples a flexible tank hose 10 with the tank supply line 30. In addition, a temperature sensor 12 can be used to determine the temperature of the medium at the outlet of the cold accumulator 7. The tank hose 10 can further be joined with the storage tank 8 by the filling coupling 19 provided on the free end of the tank hose 10, so that the gaseous hydrogen can be introduced from the reservoir into the respective storage tank 8 via the tank supply line 30. The storage tank 8 is usually safeguarded with a storage tank valve 9 (check valve).

In the method according to the invention, the cold accumulator 7 is initially cooled to a predefined operating temperature in particular of −40° C. before the actual process of filling the storage tank or vehicle tank 8. Cooling here takes place via the cooling circuit 6, which extracts heat from the cold accumulator 7.

During a first filling phase, in particular after a pressure and tightness test, a pressure ramp is then preferably traversed by means of the ramp regulator on the valve 1, so that hydrogen flows over the additional cold accumulator 2 with the filling valve 4 opened, is cooled and thereupon heated in the fuel pump or tank supply line 3, 30 (heat transfer from the tank supply line 30, in particular the fuel pump line 3 to the medium), after which it flows into the storage tank 8 by way of the temperature-adjusted cold accumulator 7 as the process continues, wherein the temperature of the medium (hydrogen) entering into the cold accumulator 7 is initially greater than the operating temperature of the cold accumulator 7, so that heat is transferred from the medium to the cold accumulator 7, causing the temperature of the medium flowing in the downstream storage tank 8 to drop comparatively quickly to the permissible or desired range (preferably −40° C. to −33° C.).

In an ensuing second filling phase, as soon as the tank supply line 30 has been cooled by the back-flowing hydrogen, the cold accumulator 7 is also cooled off again by the back-flowing hydrogen. The cooling capacity to be additionally conveyed to the cold accumulator 7 is thus only somewhat greater than the power dissipation, which depends on the insulation of the cold accumulator 7 and connecting lines.

REFERENCE LIST

| | |
|---|---|
| 1 | Valve with ramp regulator |
| 2 | Additional cold accumulator (“Alu Coldfill”) |
| 3 | Fuel pump line |
| 4 | Filling valve (inlet valve, fuel pump) |
| 5 | Hand valve |
| 6 | Cooling circuit |
| 7 | Cold accumulator (“Alu Coldfill”) |
| 8 | Storage tank |
| 9 | Storage tank valve |
| 10 | Tank hose |
| 11 | Breakaway coupling |
| 12 | Temperature sensor |
| 13 | Flowmeter |
| 14 | Flue line |
| 15 | Vent valve |
| 19 | Filling coupling |
| 20 | Cooling circuit |
| 30 | Tank supply line |
| 30a | End section |
| 30b | Section |

1. A method for filling a storage tank with a pressurized, gaseous medium in which this storage tank is filled with the aforesaid medium via a tank supply line and a filling coupling furnished on an end section of the tank supply line, wherein a cold accumulator for cooling the medium provided on said end section of the tank supply line upstream from the filling coupling is cooled to a predetermined operating temperature before the storage tank is filled, so that the medium that flows through the tank supply line in a first phase of filling the storage tank, and is heated in the tank supply line in the process, is cooled by the cold accumulator to a predefined desired temperature, wherein, once the tank supply line has been cooled by back-flowing medium, the cold accumulator is again cooled by back-flowing medium in a second phase of filling the storage tank, characterized in that the cold accumulator is cooled to this operating temperature before filling the storage tank by way of a cooling circuit, which is coupled with an additional cold accumulator provided upstream from the cold accumulator on the tank supply line.

2. The method according to claim 1, characterized in that the cold accumulator at this operating temperature exhibits a cold energy that causes the medium to be cooled by the cold accumulator to a desired temperature ranging from −40° C. to −33° C. in the first filling phase.

3. A filling device for filling a storage tank with a pressurized, gaseous medium comprising a tank supply line that can be connected with the storage tank by a filling coupling provided on an end section of the tank supply line for filling the storage tank, and a cold accumulator designed to extract or supply heat from or to the medium to be filled into the storage tank via heat transfer, wherein the cold accumulator is provided upstream from the filling coupling on the end section of the tank supply line, characterized in that the cold accumulator is connected with an additional cold accumulator for cooling the cold accumulator by way of a cooling circuit.

4. The filling device according to claim 3, characterized in that the cold accumulator is situated upstream from a tank hose of the tank supply line, wherein this filling coupling is provided on a free end of the tank hose.

5. The filling device according to claim 4, characterized in that the cold accumulator is situated upstream from a breakaway coupling of the tank supply line, wherein the breakaway coupling is designed to separate the tank hose from the tank supply line under tension.

6. The filling device according to claim 5, characterized in that the additional cold accumulator is designed to cool a section of the tank supply line upstream from the cold accumulator.

7. The filling device according to claim 3, characterized in that the cold accumulator consists of a metal body which envelops a section of the tank supply line (end section) or forms that section of the tank supply line, and that several wires are situated inside the line section enveloped by the cold accumulator or inside the line section formed by the cold accumulator.

8. The method according to claim 1, wherein the storage tank is in the form of a vehicle tank.

9. The method according to claim 1, wherein the pressurized gaseous medium is hydrogen.

10. The filling device according to claim 3, wherein the storage tank is in the form of a vehicle tank.

11. The filling device according to claim 3, wherein the pressurized, gaseous medium is hydrogen.

12. The filling device according to claim 5, wherein the cold accumulator is situated directly in front of the breakaway coupling.

13. The filling device according to claim 7, wherein the metal body is an aluminum body.

14. The filling device according to claim 7, wherein the several wires are stainless steel wires.
